(19) United States
(12) Patent Application Publication
(10) Pub. No.: US 2013/0248023 A1
(43) Pub. Date: Sep. 26, 2013

(54) Remotely Activated Fluid Control System

(71) Applicant: William Arnold Estrada, JR., Henderson, NV (US)

(72) Inventor: William Arnold Estrada, JR., Henderson, NV (US)

(21) Appl. No.: 13/426,603

(22) Filed: Mar. 22, 2012

(51) Int. Cl. F16K 37/00

(52) U.S. Cl. 137/551

(57) ABSTRACT

The remotely activated fluid control system prevents damage from leaking fluids (such as water or gas) escaping from damaged pipes by providing a user-activated controlling device that allows the user to activate a remote inline first shut-off valve in the main fluid supply line, such as when leaving the building. An integrated shut-off delay function delays the fluid shut off a preset amount of time to accommodate a currently running appliance, such as a dishwasher that needs to draw water to finish its cycle. An optional function is provided that allows a residual fluid flow to accommodate appliances that use a minimal flow to maintain normal operation. Optionally, a display control panel is provided to display system data from a flow measuring device and water temperature sensors. Optionally, a single engagement of the user-activated controlling device may restrict the fluid flow in one or multiple flow interface systems.

### FIELD OF INVENTION

The present invention relates generally to a remotely activated fluid control system, which includes remote activation of an inline shut-off valve to prevent fluid leaks.

### BACKGROUND OF THE INVENTION

Even a small amount of water from leaking or broken pipes can cause serious damage to a home or business. Plus, water damage is common and costly. The Insurance Information Institute reports that losses are in the billions of dollars annually; nationally, in 2007, water damage accounted for 22 percent of all homeowner insurance claims. In addition to the large expense, the removal and replacement of wet carpet, padding, baseboards, drywall, furniture, etc. is stressful and inconvenient for homeowners.

Recognizing the cost, time and trouble to recover from water damage due to discharge from a broken pipe or malfunctioning appliance, numerous devices have been developed to detect leakage, to prevent water damage, or to allow a homeowner to turn off the water when the house is unoccupied. Variations in type, location and activation of the various parts of the systems have been presented.

A common approach to preventing or reducing water damage has been to combine a leak-detection system with a shut-off system and an alert system. When the leak-detection system detects a leak, a signal is sent to activate one of various types of water shut-off mechanisms, often with an audible alarm for alerting the homeowner. Variation in the types and locations of each of these systems (the leak-detection system, the shut-off system, and the alert system) have been presented to attempt to solve the problem of preventing or mitigating water damage. For example, U.S. Pat. No. 5,967,171 issued to Dwyer discloses a sensor that can be placed near a major appliance, such as a hot water heater, washing machine or dishwasher. When the sensor detects water, a signal is sent (either through a direct electrical connection or wirelessly) to an actuator that mechanically activates the shut-off valve in the main waterline.

Instead of attempting to detect a leak, a second approach maintains the water in an “off state,” only allowing a limited amount of water for a particular purpose. For example, U.S. Pat. No. 6,389,852 issued to Montgomery in 2002 discloses an invention that only allows water flow from the pipes to an appliance when the appliance is turned on or in use. Thus, if the appliance malfunctions, there is no water flow to cause water damage. It provides an inline solenoid actuated valve for both the hot and cold water lines of a washing machine, and provides a control panel to sense electrical current flow to the washing machine. When the washing machine is turned on, the control panel actuates the opening of the solenoid valves to allow a preset amount of water to flow for the duration of a washing cycle.

A third type of flood prevention device accomplishes the detection of a leak through a measurement of the water flow in the pipe, instead of water detected near an appliance by a sensor. An example of this type is U.S. Pat. No. 5,251,653 issued in 1993 to Tucker which, when activated, expects no water flow (though an option is presented that allows a very low, preset flow, such as a gallon per minute threshold). If the system detects a flow, it assumes that a leak has occurred, and shuts off the water flow in the household water supply. This patent provides a control module that is electrically connected to the electronic module. The electronic module controls a hydraulic subsystem in the main water supply line. The hydraulic subsystem includes a flow meter to detect water flow when the system is activated. When this system is activated at a control panel, if the detected flow rate exceeds the preset limit of the flow meter (as will occur when a leak develops) a signal is sent from the flow meter to a shut-off device to shut off water flow within the system. The user-accessible control panel is electrically coupled to an electronic module, though the electrical wiring can be run a significant distance to allow the control panel to be located remotely from the electronic module controlling the hydraulic subsystem. The control panel merely lets the user activate and deactivate the system, but does not provide informational data concerning the water system (such as water usage or temperature), nor does it allow the user to turn off the water remotely. Additionally, the need to run electrical wiring from the out-of-the-way main water supply to a more accessible location is both inconvenient and costly.

In a fourth category of inventions that attempt to address the problem of leaking fluids, water control devices are disclosed that shut off the main water or fluid supply without the necessity of accessing the current manual shut-off valve. This is advantageous, because the manual shut-off valve for the water supply is usually located in an inaccessible location for aesthetic reasons, such as inset under a cover in a nearby sidewalk, in a basement, under the house in a crawl space, or other out-of-the way and out-of-sight location. One such patent is U.S. Pat. No. 6,945,274 issued to Davis in 2005 that provides a remote on/off control module electrically wired to an inline main water supply shut-off that prevents water flow through the supply line except when the system is activated. Another patent, U.S. Pat. No. 7,147,204 issued to Hollingsworth in 2006, discloses a control module that allows a user to remotely shut off water flow to the house or business. When the “off” button is activated, a radio frequency (RF) signal is sent from the control module to a motorized ball valve to cause it to rotate to shut off the water flow. Similarly, the water flow can be restarted by activating the “on” button, with an RF signal sent from the control module to the motorized valve.

In addition to the problems caused by leaking water, damaged or deteriorated gas lines and malfunctioning gas appliances in a residence or place of business can be a safety hazard. Gas from leaking or broken gas pipelines and appliances can cause an explosion or cause medical problems from inhalation. One patent disclosing a remote gas shut-off is U.S. Pat. No. 6,994,309 issued to Fernandez-Sein in 2006, which provides a remotely operated gas safety valve that can close a gas valve from a remote location upon detection of a gas leak, while also metering the gas. The gas usage data is supplied via wireless connection through an antenna to a neighborhood base antenna, which then transmits the data to a supervisory computer system for display, accounting, administrative, and emergency purposes. The supervisory computer system can also send a shut-off signal that is received and acted on by the gas safety valve; this provides a system that allows a utility to stop the flow of gas in household systems in case of an emergency, such as an earthquake or fire.

Additionally, leakage problems can occur with other types of fluids being transported in pipes. For example, milk in lines in dairies and liquid or gas chemicals in lines in manufacturing environments. Thus, the word “fluid” is used herein, unless otherwise stated, as any substance that flows or deforms under an applied shear stress, including gases and liquids of various kinds.

Though the systems disclosed by these patents provide restriction of fluid flow without physically accessing the fluid shut-off valve, they offer no additional benefit in managing the user's water system. Nor do any of these remote shut-off systems provide a timed delay for the shutoff, which is valuable if the user is leaving the house, but a water-using appliance has not completed its cycle. Nor do these systems allow a residual fluid flow to accommodate appliances which have a continual, but minimal fluid usage, such as pilot lights on a stove or the refrigerator ice maker.

Additionally, homeowners and businessmen have very little data concerning their fluid systems, such as gas and plumbing systems, available to them, beyond the monthly metered fluid usage displayed on the monthly bills from the utilities. This aggregate monthly water usage amount does not allow the user to determine the fluid usage for a particular activity. Nor do users have a means to obtain temperature data for the hot or cold water. Displaying the temperature of the hot water in a convenient location would allow the user to monitor the temperature and reduce it, when possible, to save energy, as maintaining the temperature of the hot water is a significant cost to a homeowner.

Thus, though a variety of fluid control systems have been developed in an attempt to reduce fluid damage to homes and businesses from leaking pipes and appliances, none fulfill the need for convenient user-accessible controls that can be triggered when leaving the residence or business to activate a remote shut-off valve while allowing the option for a minimal fluid flow and a delay function.

### BRIEF SUMMARY OF THE INVENTION

The present invention is directed to a remotely activated fluid control system that includes both a flow interface to control (and, optionally, to measure) fluid flow into the house, and a remote user-activated controlling device to allow the user to remotely shut off fluid flow to prevent leakage and damage, particularly when the user leaves the house for a period of time. Though the remotely activated fluid control system is readily applied to water flow in a house, the control of other fluids, such as gas, is also provided.

The flow interface includes a shut-off valve downstream of a standard mainline shut-off valve for the building. The shut-off valve is activated when a signal is received from the user-activated controlling device. The user may delay the activation of the shut-off valve a selected length of time. The shut-off valve may be configured to shut off the fluid completely, or may be configured to allow only a limited residual fluid flow.

Optionally, in a further aspect, the flow interface may also include a flow meter for determining fluid flow data. In this aspect, the shut-off valve and the flow meter are in wireless communication with a remote control panel having a display for conveying fluid data to the user. The flow interface is configured with a transmitter for transmitting the flow data to the control panel and with a receiver for receiving a system on/off signal to control the fluid flow. The flow interface may also optionally include cold and hot water temperature sensors to provide temperature data that are viewable by the user on a display control panel.

The user-activated controlling device is located remotely from the flow interface system, but is in communication with it. In most embodiments it is in wireless communication. It has appropriate electronic components for the functions provided. The user-activated controlling device is operable to transmit data to the flow interface system, including sending system on/off signals to cause the shut-off valve to selectively stop or allow the fluid flow. In some embodiments, the user-activated controlling device is operable to receive fluid system data from the flow interface system.

The user-activated controlling device may be a wireless key fob-type controlling device (FIGS. 2, 4), a wireless control panel-type controlling device (FIGS. 6, 10), or a combination of a key fob-type controlling device in wireless communication with a fluid control panel (or a home security system control panel) wired to the flow interface (FIG. 11).

An optional metering device measures fluid flow to determine fluid usage. The fluid flow data are transmitted to the control panel where they are displayed. The control panel preferably calculates and displays a monthly usage amount, a daily usage amount and, upon manual selection, a running total or “current” amount. The user manually engages a start current usage button to begin displaying the running total of water usage since the engagement of the current usage button, which is incremented upward as the metering device continues to transmit the flow data to the control panel over time.

Another aspect of the invention is an integrated delay. The delay allows a user who is leaving home to delay the activation of the shut-off valve, such as would be desirable if the dishwasher, washing machine, or the like are running. The amount of delay is manually adjustable by the user. After the expiration of the amount of time selected by the user for the delay, a system-on signal will be sent to the shut-off valve to stop the flow of water.

Optionally, in another aspect, the control panel can be integrated into a home security system control panel to allow both systems to be controlled from a single control panel and, optionally, to allow a single key fob-type user-activated controlling device to activate both systems. This aspect may provide a reduction in installation costs (only a single control panel need be installed, instead of two separate ones) and may provide an increase in convenience, as both systems can be activated simultaneously, such as by a single key fob-type user-activated controlling device. In a further aspect, a single key fob-type user-activated controlling device can be configured to transmit signals to both a fluid control system control panel and to a home security system control panel, upon the engagement of one or multiple buttons.

An object of the remotely activated fluid control system of the present invention is to allow a user to conveniently shut off the fluid in the main fluid supply line, such as when the user leaves the building for an extended period.

Another object of the present invention is to optionally provide a very low, residual fluid flow to accommodate appliances that use a minimal flow to maintain normal operation.

A further object of the present invention is to optionally provide a delay in the shutoff of the fluid in the main fluid supply line.

An additional object of the present invention is to provide a user with the ability to easily shut off the water to the building from a location remote from the shut-off valve.

These and other objects, features, and advantages of the present invention will become more readily apparent from the attached drawings and from the detailed description of the preferred embodiments which follow.

### BRIEF DESCRIPTION OF THE SEVERAL VIEWS OF THE DRAWINGS

The preferred embodiments of the invention will hereinafter be described in conjunction with the appended drawings, provided to illustrate and not to limit the invention, where like designations denote like elements, and in which:

FIG. 1 is a diagram of the flow interface that controls the fluid flow of the first embodiment of the present invention, in which the flow interface is in wireless communication with a key fob-type user-activated controlling device;

FIG. 2 is a diagram of the key fob-type user-activated controlling device of the first embodiment of the present invention;

FIG. 3 is a diagram of the flow interface of the second embodiment of the present invention, in which the flow interface is in wireless communication with a key fob-type user-activated controlling device;

FIG. 4 is a diagram of the key fob-type user-activated controlling device of the second embodiment of the present invention;

FIG. 5 is a diagram of the preferred third embodiment of the flow interface of the present invention, which is in wireless communication with a control panel-type user-activated controlling device;

FIG. 6 is a diagram of the control panel of the preferred third embodiment of the present invention, which is in wireless communication with the flow interface system;

FIG. 7 is a diagram of the flow interface of a fourth embodiment of the present invention in which the shut-off valve and the metering device are integrated into a single unit with a single transceiver;

FIG. 8 is a diagram of an inline hot water temperature sensor 24 installed within hot water line 27, which is an element of the flow interface usable with the third through sixth embodiments of the remotely activated fluid control system of the present invention;

FIG. 9 is a diagram of a clip-on type hot water temperature sensor 24 installed on the hot water line 27, which is an element of the flow interface usable with the third through sixth embodiments of the remotely activated fluid control system of the present invention;

FIG. 10 is a diagram of the control panel of the fifth embodiment of the remotely activated fluid control system of the present invention, which is in wireless communication with the flow interface system;

FIG. 11 is a diagram of the control panel in wireless communication with a key fob-type controlling device of the sixth embodiment of the remotely activated fluid control system of the present invention, which is electrically wired to the flow interface system; and

FIG. 12 is a diagram of the flow interface of the present invention, as applied to a gas supply line 52.

Like reference numerals refer to like parts throughout the several views of the drawings.

### DETAILED DESCRIPTION OF THE INVENTION

Shown throughout the figures, the present invention is directed toward a remotely activated fluid control system that includes a flow interface (configured to control fluid flow in the fluid lines, such as water or gas lines) and a wirelessly connected, user-activated controlling device (configured to remotely trigger the flow interface to restrict or allow fluid flow). The remotely activated fluid control system prevents fluid damage from leaking pipes or malfunctioning appliances while a user is away by allowing him to remotely shut off the fluid flow into the fluid lines, such as when leaving the building. Conveniently, the user needs only to engage a button on the user-activated controlling device to send a wireless system-on signal to remotely activate a shut-off valve disposed within the main fluid supply line. Similarly, upon returning to the building, the user engages a second button on the user-activated controlling device to wirelessly send a system-off signal to restore fluid flow. Thus, the fluid is restricted when the system is activated, so damage is eliminated or greatly reduced, even if a pipe leak occurs while the user is away.

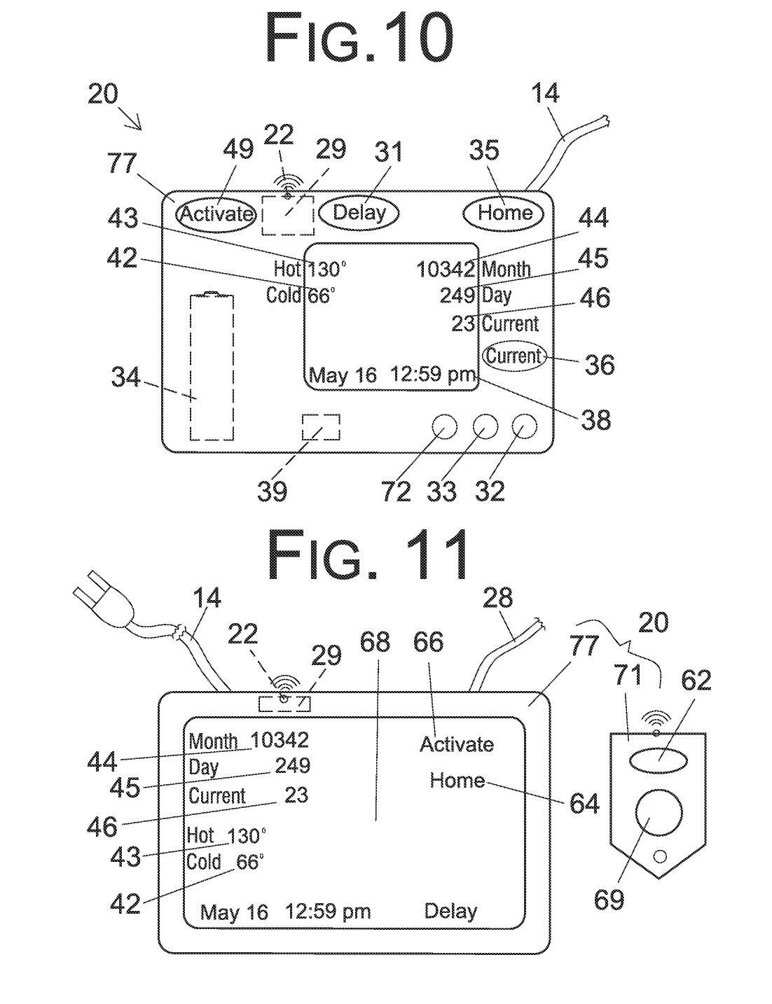

In the first and second embodiments of the remotely activated fluid control system of the present invention, the wireless user-activated controlling device is a portable key fob-type device that sends system-on and system-off signals to the flow interface to control the fluid flow, as seen in FIGS. 2, 4. In the third and fifth embodiment, the user-activated controlling device is a wireless display control panel configured to display fluid data (such as fluid usage and fluid temperature data) to the user, as seen in FIGS. 6, 10. In the sixth embodiment, the user-activated controlling device is a combination of a key fob-type controlling device in wireless communication with a control panel, with the control panel wired to the flow interface, as seen in FIG. 11.

A variety of functions are also presented that are usable with any of the types of presented user-activated controlling devices. An integrated delay function allows the user to delay the shutoff of the fluid for a limited, defined period of time. The residual flow function allows a minimal residual fluid flow to accommodate appliances that use a small amount of fluid on a continual basis, such as a refrigerator ice maker or a gas pilot light on an oven or range (as opposed to completely shutting off the fluid flow when activated). Optionally, the user-activated controlling device can be integrated into a home security system. Yet a further function provides a metering device that acquires fluid system data that are displayed on the display control panel to assist the user in managing fluid usage, and includes temperature sensing devices to notify the user of both the hot and cold water temperatures.

Though the remotely activated fluid control system is described herein as applied to a house for convenience of discussion, it is not limited to houses, but is configured to be used in any residential dwelling or commercial building, which is herein referred to generally as a “building.” Similarly, the “user” may be any user of the residential dwelling or commercial building, such as a homeowner, renter, business owner, building maintenance personnel, custodian, or the like. Furthermore, though the remotely activated fluid control system is herein fully described as applied to water flow in a house for conciseness of discussion, other fluids can similarly be controlled and are within the scope of the invention.

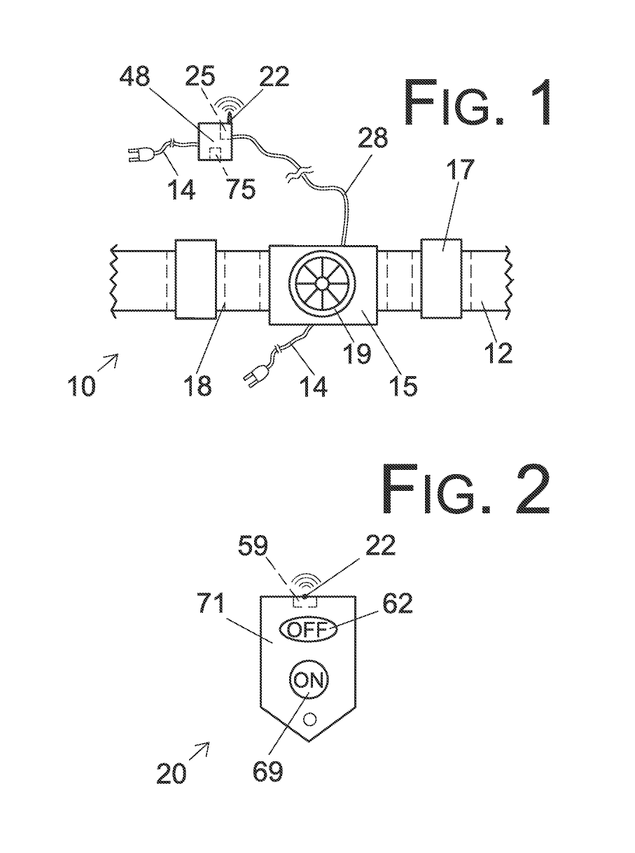

Referring now to the basic embodiment of FIG. 1 and FIG. 2, the remotely activated fluid control system includes the flow interface of FIG. 1, shown generally as reference number 10, and a user interface, the remote user-activated controlling device of FIG. 2, shown generally as reference number 20.

As shown in FIG. 1, the flow interface system (illustrated installed on water supply line 12) comprises a shut-off valve 15 operable to control the flow of fluid and an actuator 48 operable to actuate the shut-off valve 15. Actuator 48 is configured with both a receiver 25 and a microprocessor 75. The receiver 25 is operable to receive system on/off signals from the user-activated controlling device 20. The system on/off signals that are sent and received include a system-on signal and a system-off signal that designate the closing or opening of shut-off valve 15, respectively. The actuator's circuitry (designated “microprocessor 75”) is configured to receive the system on/off signals from the receiver 25 and to distinguish between the two signals. The microprocessor 75 then causes valve 15 to be moved to the desired position. Actuator 48 preferably includes an internal or external antenna 22 configured to increase the reception of signals sent by a transmitter 59 of the user-activated controlling device 20, which in the first embodiment is a key fob-type controlling device 71. Actuator 48 is electrically connected via electrical wiring 28 to the shut-off valve 15. Upon receipt of a system-on signal, the actuator 48 actuates shut-off valve 15 to close and restrict fluid flow. Upon receipt of a system-off signal, the actuator 48 actuates the shut-off valve 15 to open and allow fluid flow.

The flow interface is designed so that it can be easily installed inline in a conventional fluid supply line of a dwelling, shown as fluid supply line 12, generally immediately downstream of a main fluid shut-off valve. Thus, depending on the location of the main fluid supply line, the flow interface 10 may be installed in a garage, basement, crawl space or some other less visible location by using standard pipe couplers 17, such as unions, on either end of the supply line 12 that is cut to allow installation.

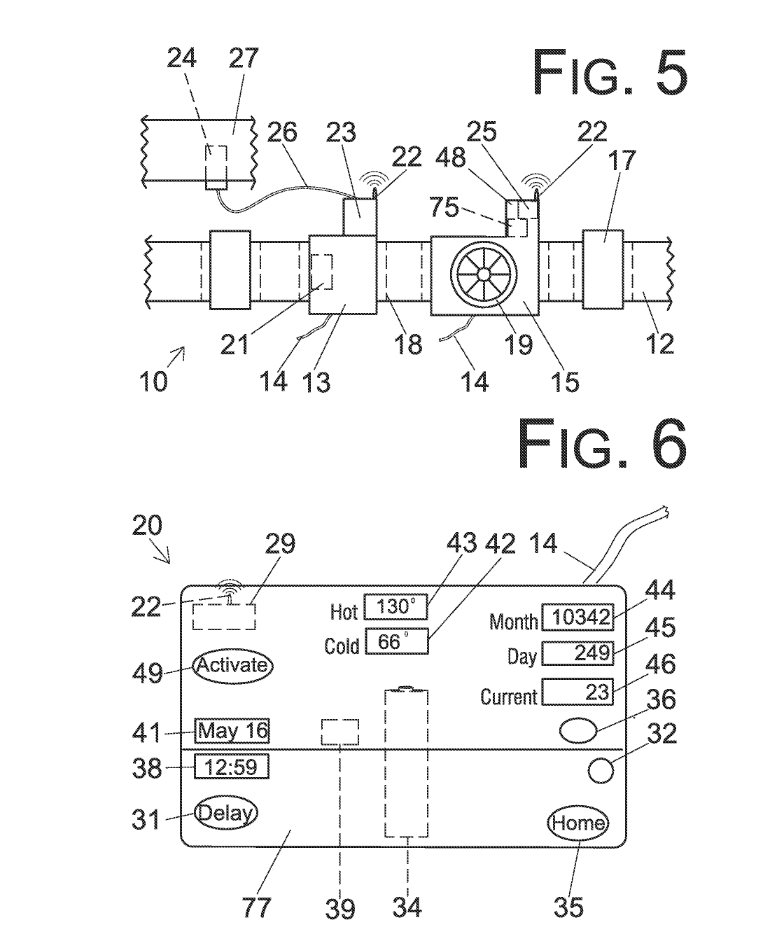

For convenience of installation, the length of wiring 28 may be minimized by placing the actuator 48 in the immediate vicinity of the shut-off valve 15. For example, if the shut-off valve 15 is located on a side wall of a garage, the actuator 48 may be installed in close proximity on the same wall. Alternatively, as shown in FIG. 5 the actuator 48 may be incorporated into the shut-off valve 15 with the actuator 48 directly wired to control the valve 15 within a single housing.

The user-activated controlling device 20 of the first embodiment comprises a hand-held remote, such as a key fob-type controlling device 71, as shown in FIG. 2. The user-activated controlling device 20 is configured with a transmitter 59 (which includes, or is associated with, circuitry and antenna 22) that is operable to send at least two wireless signals (a system-on signal and a system-off signal) that receiver 25 of actuator 48 is configured to receive.

The key fob-type controlling device 71 is configured with an away system-on control 69 and a home system-off control 62. When the system-on control 69 is activated by the user, the transmitter 59 of the key fob-type controlling device 71 is triggered to send a wireless system-on signal (via internal or external antenna 22) to the receiver 25 of actuator 48. Upon receipt of the system-on signal, actuator 48 controls shut-off valve 15 to restrict fluid flow. Similarly, when the user activates the system-off control 62, the receiver 25 is triggered to send a wireless system-off signal to the actuator 48. Upon receipt of the system-off signal, actuator 48 controls shut-off valve 15 to turn off the system and to allow fluid flow. The actuator 48 may control shut-off valve 15 by supplying electrical, pneumatic or hydraulic power to the valve 15, thereby selectively preventing or allowing fluid flow through the main line 12.

The user has convenient access to the hand-held key fob-type controlling device 71, so he can easily activate the system when he is leaving the building. The user may be leaving for only a few hours or for an extended vacation, but the remotely activated fluid control system continues to restrict the fluid; the fluid will remain off until the user returns home and engages the system-off control 62. Thus, even if a pipe begins to leak while the user is away from the building, there is no fluid pressure or fluid flow. For example, if a water pipe bursts, there will be no water damage or the damage will be extremely minimal, as opposed to the flooding of a whole building that often occurs when the flow continues unabated. Or if a gas pipe starts to leak, there will be no gas flow, so there will be no possibility of an explosion. When the user returns, the system-off control 62 is engaged, causing the transmitter 59 to transmit a system-off signal to the receiver 25 of actuator 48 that signals shut-off valve 15 to open to allow fluid flow. Of course, the ability for the user to remotely turn off the fluid flow to the building may also be used at other opportune times, such as when the user detects a leaking pipe, when a toilet overflows, when an appliance malfunctions, when a user smells gas, when a plumber or gas repair technician is repairing a leak, etc.

The user-input buttons, system-on control 69 and system-off control 62, are preferably standard momentary switches, as are known in the art. The momentary switch may be a throw switch, a toggle switch, a push button switch, a rocker switch, or the like. In the first, third and sixth embodiment, the user-input buttons are disposed on a small, portable, handheld device that may be suitable for attaching to a key chain, herein designated as the key fob-type controlling device 71.

The inline shut-off valve 15 is actuated by the system on/off signals from user-activated controlling device 20 (via actuator 48) to selectively allow or prevent fluid from flowing through main line 12 and thus selectively allow or prevent fluid from flowing through the building. Shut-off valve 15 is a standard inline valve, such as a solenoid valve, poppet valve, or any other pneumatic, electro-pneumatic, hydraulic, electro-hydraulic, electric, or mechanically actuated valve that is operable for shutting off or turning on fluid flow. Valve 15 is normally in the un-activated open position in which fluid flow is allowed through the main line 12. Upon activation based on receipt of a system-on signal, valve 15 is closed and fluid flow is stopped. Though shut-off valve 15 is actuated remotely from user-activated controlling device 20 via actuator 48, it may optionally be provided with a manual valve with a manual control. This is shown as manual handle 19 which is operable to activate a manually operable shutoff, which can be a gate valve, ball valve, globe valve, butterfly valve, or any type of valve that can be manually operated to stop fluid flow.

Optionally, instead of shutting off the flow of fluid, the shut-off valve 15 can be configured to restrict the flow of fluid to allow only a very low, preset residual flow, such as a gallon or half gallon per minute threshold. This functionality accommodates appliances that use a minimal amount of fluid in their normal operation, such as refrigerator ice makers, automatic pet waterers, indoor automatic plant waterers, and pilot lights in ovens, ranges, dryers, and hot water heaters. In this aspect, as discussed above, when the system-on control 69 is activated, the transmitter 59 sends the system-on signal to receiver 25 of actuator 48, which then controls the valve 15. But, in opposition to the discussion above, the shut-off valve 15 does not completely close off the fluid flow, but restricts the flow to the very low, preset residual flow.

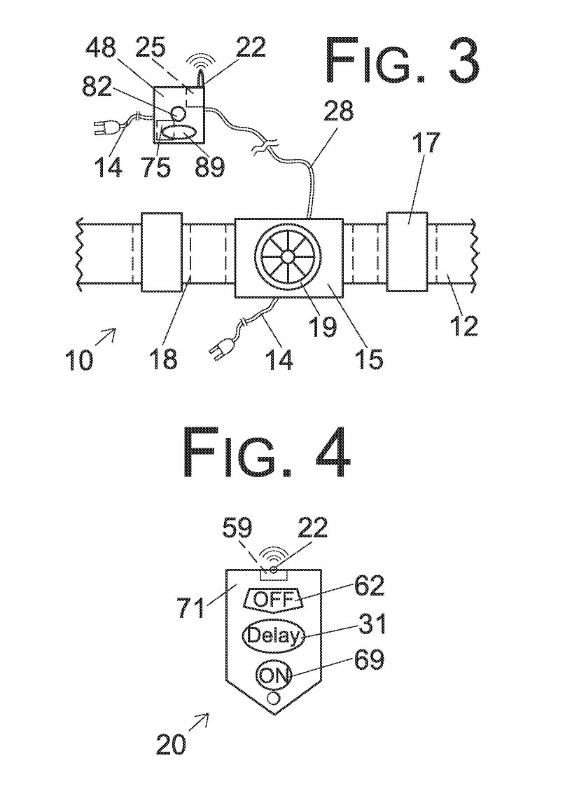

FIG. 3 and FIG. 4 show a second embodiment of the remotely activated fluid control system of the present invention. The second embodiment includes the features of the first embodiment, with the addition of manual controls (buttons 82, 89) on the actuator 48 and with the addition of a delay function (initiated by delay button 31 on the user-activated controlling device 20). Actuator system-on control 89 functions similarly to controlling device system-on control 69, in that both trigger actuator 48 to send a system-on signal to the shut-off valve 15 to restrict fluid flow. But the system-on signal from the system-on control 69 is transmitted wirelessly (via transmitter 59 and receiver 25) to actuator 48, while the actuator system-on control 89 is disposed on, and directly activates, the actuator 48. Similarly, the actuator system-off control 82 functions similarly to controlling device system-off control 62, in that that both trigger actuator 48 to send a system-off signal to the shut-off valve 15 to allow fluid; but the system-off signal from the system-off control 62 is transmitted wirelessly (via transmitter 59 and receiver 25) to actuator 48, while the actuator system-off control 82 is disposed on and directly activates the actuator 48. Manually activated system-on control 89 and system-off control 82 are preferably standard momentary switches.

The manually activated buttons 82, 89 disposed on actuator 48 allow a user who might be near the actuator 48 to control the remotely activated fluid control system without the use of the remotely operated user-activated controlling device 20. Such control may be desirable, for example, when the user is outside in the garage and sees a leak at the hot water heater. The user can manually engage the system-on control 82 to activate the shut-off valve 15 to immediately shut off the fluid flow.

The second embodiment of the remotely activated fluid control system also provides a system-on delay function. The delay function allows a user to delay the activation of the shut-off valve for a designated amount of time, thus allowing the fluid to flow for the designated length of time after the engagement of delay button 31 before restriction of fluid flow.

Manual engagement of the delay button 31 allows the user to delay the system-on activation for a particular length of time. The length of the delay time is pre-set. The delay button may be configured to allow one manual engagement to delay the time of transmission of the system-on signal the pre-set length of time; or, alternatively, a pre-set length of time can be incremented with each engagement of the delay button 31.

If the user-activated controlling device is configured to allow only a single engagement of the delay button 31, the pre-set length of delay time may be in the one- to four-hour range. For example, if the delay time length is pre-set for two hours, engaging the delay button 31 one time will delay the system-on activation and the shut-off of the fluid flow for two hours to allow a dishwasher or washing machine to complete its cycle.

Alternatively, the user-activated controlling device 20 (key fob-type controlling device 71) may be configured to allow the delay button 31 to be engaged multiple times, incrementing the delay time a pre-set length of time with each pressing of the delay button 31. For example, the delay button 31 may be configured to increment the delay time ten minutes with each engagement of the button 31. Then, if the delay button 31 is pressed one time, the system-on activation will be delayed ten minutes, but if the delay button 31 is engaged three times, the system-on activation will be delayed thirty minutes.

A timing mechanism is operative to control the delay duration, as input by the user. For example, the delay button 31 may be an operative momentary switch that is manually manipulated to activate a timing mechanism, with the timing mechanism controlling the length of time before a wireless system-on signal is sent via a transmitter 59 to receiver 25 of actuator 48 to control the remote shut-off valve 15. A standard timing mechanism may be used, as is known in the art, such as a time delay relay, a mechanical timer, a microchip controlled timer, etc.

FIGS. 5 and 6 disclose the third preferred embodiment of the remotely activated fluid control system in which the shut-off valve 15 comprises a standard remotely-activated shut-off valve and in which the user-activated controlling device comprises a display control panel configured to display fluid data, such as fluid usage and fluid temperature data, to the user.

As shown in FIG. 5, the flow interface system comprises shut-off valve 15, a metering device 13, and, optionally, temperature sensors 21 (FIGS. 5, 7), 24 (FIGS. 5, 8, 9). The flow interface system installed on the fluid supply line (shown as water supply line 12) provides fluid system data to the control panel 77 (FIGS. 6, 9, 10). The metering device 13 is configured with a meter communication device (referred to as “meter transmitter 23”). Meter transmitter 23 is configured with at least a transmitter configured to transmit fluid usage data to the control panel 77.

The actuator 48 (including the microprocessor 75 and receiver 25) of this embodiment is incorporated into the valve 15, as is commercially available as a remotely actuated valve. The valve is opened or closed, as described above, based on the system on/off signal received.

As shown in FIG. 6, the user-activated controlling device 20 comprises a display control panel 77 that allows user input, that wirelessly transmits on/off signals to flow interface 10 (FIG. 5) to control the operation of valve 15, that wirelessly receives flow system data from flow interface 10, and that computes and displays totals and usage information based on the received fluid system data from the flow interface 10. The control panel 77 is operative to provide wireless communication with the flow interface 10. Because the user preferably has convenient access to the control panel 77 to activate the fluid shut-off valve 15 when he is leaving the building (or to deactivate the system to allow fluid flow when he returns), the control panel 77 is designed to be located within the building, such as on a wall beside the door at which the user enters and exit.

The control panel 77 (FIG. 6) includes a variety of user-input buttons including an away system-on activate control 49, a set delay button 31, a current usage button 36, and a home system-off deactivate button 35. A variety of displays are also provided for the user. These include a date display 41, a time display 38, a hot water temperature display 43, a cold water temperature display 42, a monthly usage display 44, a daily usage display 45, and a current usage display 46. The units of the measurements displayed may, of course, vary based on the standard units of the country in which the remotely activated fluid control system is sold, such as gallons or liters. The user-input buttons are preferably standard momentary switches, as are known in the art.

The system-on control 49 (FIG. 6) is engaged by the user to trigger the circuitry of the control panel 77 to send a system-on signal through receiver 25 (FIG. 5), or optionally, transceiver 29 (FIG. 7) to the shut-off valve 15 to shut off (or restrict to a limited, residual flow) the fluid to the building. The user-input buttons are preferably standard momentary switches, as are known in the art.

Shut-off valve 15 (FIG. 5) is a standard, remotely controlled inline valve that is normally in the open position to allow fluid flow. It is actuated remotely via the system on/off signals from the control panel 77 to selectively allow or restrict (fully or to a limited, residual flow) fluid from flowing through main line 12.

The metering device 13 (FIG. 5) is operable to determine the fluid flow passing through the device. The metering device 13 provides a water flow rate measurement in standard units, such as in gallons per minute, which is then transmitted by the meter communication device 23 to the control panel 77. The control panel circuitry (interior of the housing of control panel 77) is configured to total the units of the water flow rate for a preselected length of time, such as for the day and for the month. For example, the daily totalized measurement is displayed in the daily usage display 45. The totalized monthly water usage is displayed in the monthly usage display 44.

The daily totalized measurement is preferably derived by totaling the received flow rate from midnight to midnight. It may optionally be a display of the previous day's usage or a running total of the current day's usage.

The total monthly water usage can be calculated by the control panel circuitry based on the data received from the metering device 13. The total monthly water usage amount is displayed as the monthly usage display. This total monthly water usage amount can be preset to reflect the usage from the last month or can be preset to reflect the running total of the usage of the current month.

Additionally, the control panel 77 (FIG. 6) is configured to display the metered fluid usage over a prescribed time. The user engages a button, such as a “current usage” button 36, which initializes the current usage at zero with the metered fluid usage flow data received thereafter totaled to obtain the amount of fluid used since the pressing of the button 36. The current fluid flow amount (the units of fluid of the metered fluid usage from the time of the engagement of the current usage button 36 to substantially the present time) is incremented in the current usage display 46. The display 46 of the current usage running total is valuable in determining the amount of water used by specific appliances or activities. For example, a user can engage the current usage button 36 before starting the washing machine to generally determine how much water is used during a washing cycle. Or, it may be advantageous to display the current water usage during certain activities such as filling a spa, washing the car, or resolving a dispute between roommates as to the amount of water used during a shower. Displaying the usage of other fluids may also be beneficial, such as displaying the current usage running total of gas usage for heating on a particularly cold morning.

The third embodiment of the smart water system of the present invention also provides the delay function. The delay function allows a user to delay the sending of the system-on signal to the shut-off valve 15 for a designated amount of time.

Optionally, the valve 15 may provide a complete shutoff of the fluid or may be preset to allow a very low, residual flow rate, as described above.

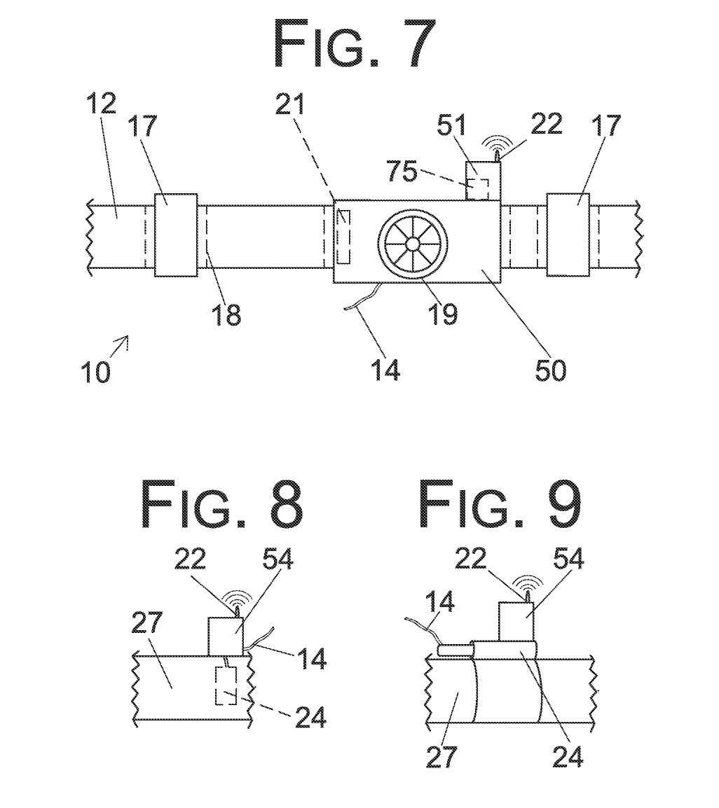

An additional function that is optionally provided by the remotely activated fluid control system of the current invention is the obtaining of hot and cold water temperature data as part of the fluid system data and the remote display of the hot water temperature 43 (FIG. 6) and cold water temperature 42 on the control panel 77. A cold water temperature sensor 21 (FIG. 5) is provided that is operable to sense the temperature of the cold water line 12. The cold water temperature sensor 21 can be located near metering device 13 so as to share the transmitter 23. A hot water temperature sensor 24 (FIGS. 5, 8, 9) is provided that is operable to sense the temperature of the hot water in the hot water line 27 (FIGS. 5, 8, 9) and is operable output that temperature data. Any of the variety of types of water temperature sensors as are known, or may become known, in the art may be used for the hot water temperature sensor 24 and cold water temperature sensor 21. The types of hot water temperature sensors 24 that may be used with the invention include both an inline sensor, as shown in FIG. 8, or an external clip-on type sensor for ease of installation (i.e., the hot water line need not be cut to install the sensor), as shown in FIG. 9. Preferably the cold water temperature sensor 21 comprises an inline sensor associated with the metering device 13.

The hot water temperature data may be conveyed to the control panel 77 in any of a variety of methods. FIG. 5 shows the hot water sensor 24 connected by wire 26 to the transmitter 23 of the metering device 13, which then transmits the received hot water temperature data wirelessly to the control panel 10. Alternatively, as shown in FIGS. 8, 9, the hot water temperature sensor 24 may be outfitted with a separate transmitter 54 that is operable to transmit the hot water temperature data to the control panel 77.

For convenience of the user, the control panel 77 (FIG. 6) may also display the date 41. A company logo may also be printed, stamped, or otherwise embellished on the face of the control panel 77. Any of a variety of labels to assist the user in understanding and using the control panel 77 may optionally be included. Optional expansion buttons 32 may be included to provide a user-interface for any functionality that may be added later to the remotely activated fluid control system.

The control panel 77 (FIG. 6) housing can be formed similarly to an alarm security system control panel (or may be used to additionally control an alarm security system). The control panel 77 may be open or may have a hinged cover that can be opened to reveal the user-input buttons and the displays. The user-input buttons and the displays are not limited to the arrangements shown, but can be varied based on manufacturing requirements, ease of use, aesthetics and the like. Although the displays are shown as individual displays, the displays may be grouped into a combined display area, as shown in FIG. 10. The displays are configured to show letters and numbers representing the data viewable by the user. The displays can be any standard display type, but is preferably an economical, low-energy type. For example, light-emitting diodes (LEDs), an electroluminescent panel (ELP), cold cathode fluorescent lamps (CCFL), liquid crystal diodes (LCDs) or the like, may be used.

The flow interface 10 (metering device 13 and the shut-off valve 15) is designed for easy installation in an existing or new fluid supply line 12 by removing a comparable length of pipe from the fluid supply line 12. Pipe couplers 17 are then installed on the cut ends of the cut fluid line 12 to insert the flow interface 10. The exact configuration of associated fittings required to install the flow interface can be customized by the installing plumber to fit the installation location, particularly to meet the needs of existing fluid line configurations.

Then the flow interface 10 is electrically connected to the electrical line 14, either by plugging an attached electrical plug into an electrical socket or by directly wiring the flow interface into the electrical wiring. Preferably the electrical socket or electrical wiring is protected by a ground fault detector for safety.

The metering device 13 and the shut-off valve 15 may be provided as an integral unitary valve and meter combination structure 50, as shown in FIG. 7, or may be provided as separate elements to be installed separately, such as shown in FIG. 5. Optionally, the receiver 25 of actuator 48 and flow meter transmitter 23 of the first embodiment may be combined into a single transceiver unit 51 (FIG. 7).

FIG. 7 shows a variation of the flow interface 10 that is similar to the flow interface of the third embodiment of FIG. 5, but the functionality is encompassed within a single modular unit that may provide benefits in ease or cost of manufacturing, in packaging and transport, and/or in simplicity of installation. In FIG. 7, the metering device 13 and shut-off valve 15 are combined into a single integral unit 50 with the receiver 25 and transmitter 23 combined into transceiver 51, but retain the functionalities as described in the first embodiment.

FIG. 10 shows a fifth embodiment of the control panel 77 that is functionally equivalent to the control panel 77 of the third embodiment of FIG. 6, but the display is a single, large display panel, as opposed to the individual displays of the control panel 77 of the third embodiment. The control panel 77 of the fifth embodiment also demonstrates a variation in the arrangement of the user-input buttons.

In the sixth embodiment, as shown in FIG. 11, the user-activated controlling device comprises both a display control panel 77 and a key fob-type controlling device 71, with the key fob-type controlling device 71 in wireless communication with the control panel 77. The control panel 77 is shown connected by electrical wiring 28 to the flow interface 10 (FIGS. 1, 3, 7, 12). The control panel of this sixth embodiment may be located near the flow interface 10 to minimize the length of the wiring that must be run, which is desirable in retrofitting a building with the fluid control system. Optionally, which may be practical in new construction, the control panel, though wired, may be located remotely, such as beside a building exit door, with the wiring run during construction before the walls are finished. In a further option, the control panel 77 of this sixth embodiment may be in wireless communication with flow interface 10, as described above. The control panel 77 may also optionally control multiple shut-off valves to control multiple fluids, such as both gas and water. Additionally, the control panel 77 may also control a home security system.

The control panel 77 of this sixth embodiment also comprises a touch screen 68 that is used to display flow system data and to allow user input, although the display control panels of FIGS. 6, 10 are also usable in this embodiment. The touch screen displays distinct areas with displayed labels, such as the activate area 66 of touch screen 68 that serves the function of the button-type system-on control 49, with touching of the screen at the activate area 66 activating the system. Or similarly, the touching of the displayed home area 64 of touch screen 68 deactivates the system and restores fluid flow.

Also shown in association with the control panel 77 of FIG. 11 is a fob control button 69 that is installed on a key fob-type device 71, which is configured to send a wireless signal. When the fob system-on control 69 or system-off control 62 is engaged, the fob-type device 71 is operable to wirelessly send a system-on or system-off control signal to the control panel 77, which communicates the system-on or system-off control signal to the actuator 48 which controls the shut-off valve 15. (Optionally, the fob-type device 71 may be operable to wirelessly send the system on/off signals directly to the actuator 48, as described in the first two embodiments.)

Thus in the sixth embodiment, the user can turn the system on or off by using the fob-type controlling device 71 to transmit the appropriate signal to the control panel 77, or, if more convenient for the user, he may directly activate and deactivate the system by use of the control panel controls. When the user desires, he can additionally view the fluid system data displayed on the control panel. Though similar to the second embodiment in that the fob-type controlling device allows the user to remotely open or close the valve 15, the sixth embodiment additionally provides data display.

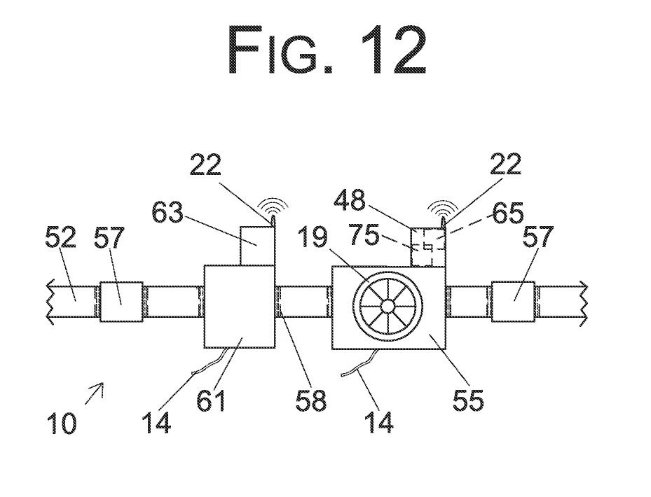

The communication protocol used between the user-activated controlling device 20 (FIGS. 2, 4, 6, 10, 11) and flow interface 10 (FIGS. 1, 3, 5, 7, 12) may be any standard wireless communication protocol, as is known or becomes known in the art, including WIFI, cellular, any of various radio frequency communications, or the like. Preferably, the unlicensed 2.4 GHz or the 900 MHz frequencies that are popular for cordless phone usage may be utilized. The communication devices 59 (FIGS. 2, 4), 25 (FIGS. 1, 3, 5), 23 (FIG. 5), 29 (FIGS. 6, 10, 11), 51 (FIG. 7), 54 (FIGS. 8, 9), 63, 65 (FIG. 12) may be configured with internal or external antennas 22, for better reception and transmission.

The user-activated controlling devices 20 (including key fob-type controlling device 71 of FIGS. 2, 4, 11 and control panel 77 of FIGS. 6, 10, 11) and the flow interface 10 (FIGS. 1, 3, 5, 7, 12) may be powered by battery power, by household electrical current 14 (which for safety may be transformed to a lower voltage direct current), or by electrical current with a battery 34 (FIGS. 6, 10) backup.

Preferably, the control panel 77 is powered by standard 100-240 volt alternating current (AC) 14 with a battery backup 34. The AC may be received by a transformer and transformed into current at a lower voltage direct current (DC) such as 12-24 volts. Preferably the metering device 13 and the shut-off valve 15 are powered by standard 100-240 volt alternating current (AC) 14 which is received by a transformer and transformed into current at a lower voltage direct current (DC) such as 12-24 volts.

Optionally, in another aspect illustrated by FIG. 11, the user-activated controlling device 20 can be integrated into a home security system control panel to allow both systems to be controlled from a single control panel and, optionally, to allow a single key fob-type user-activated controlling device to activate both systems. To integrate the user-activated controlling device 20 into a home security system control panel, the security system control panel is configured to not only arm the security system, but to also send the fluid control system-on signal and system-off signals to the flow interface 10. Thus the same security system activation signal that is typically sent to the security control panel upon engagement of the security system activation button on the security key fob-type device provides the only trigger needed to additionally activate the flow system interface 10 to restrict water flow or to restrict both water and gas flow. Optionally, as shown in FIG. 11, the security control panel may also be configured to receive and display some or all of the fluid system data available in some embodiments of the fluid control system. This aspect may provide a reduction in installation costs (a single control panel to install, instead of two) and may provide an increase in convenience, as both systems can be activated simultaneously, such as by a key fob-type device.

In the situation in which a security system control panel is already installed with a corresponding key fob device, a replacement key fob device may be supplied that, upon engagement of a single system-on control or a single system-off control, is configured to transmit a signal to both the installed security system control panel and to a newly installed corresponding fluid control panel. Consequently, again, a single engagement of a system-on control or a system-off control allows the user to activate or deactivate both systems.

A seventh embodiment demonstrating the application to another fluid is shown in FIG. 12. The remotely activated fluid control system can additionally, or optionally, be advantageously used to control the flow of other fluids, such as shown by the propane or natural gas line 52. If the flow interface 10 is used to control gas, it will include a gas shut-off valve 55 and a gas metering device 61 and the fluid system data provided by the flow interface to the control panel will be gas flow rates and, optionally, gas temperature. Both the gas shut-off valve 55 and the gas metering device 61 are configured with communication systems, shown as gas receiver 65 (equivalent to receiver 25 above) and gas meter transmitter 63 (equivalent to transmitter 23 above). Optionally, the functionality of the receiver 65 and transmitter 63 may be combined into a single unit (shown as transceiver 51, FIG. 7), the functionality of the gas shut-off valve 55 and gas metering device 61 may be combined into a single unit (shown as integral unitary valve and meter combination structure 50), or the functionality of all four (receiver 65, transmitter 63, gas shut-off valve 55 and gas metering device 61) may be combined into a single unit. The sending of a single system-on signal or system-off signal by the user-activated controlling device 20 may trigger one flow interface system or may trigger multiple flow interface systems to restrict the flow of fluids. For example, upon leaving his home the user may wish to turn off both the water and gas with a single activation.

Variances in installation of the remotely activated fluid control system will depend on the type of pipe carrying the fluid. For example, FIG. 5 shows the system installed with soldered joints 18, whereas FIG. 12 shows the system installed with threaded joints 58.

The same control system 20 can be used to control water, gas, or gas and water simultaneously. If the smart control system is designed to control gas in addition to water, when the system-on control 69 (FIGS. 2, 4), 49 (FIGS. 6, 10), 66 (FIG. 11) is engaged, an additional gas system-on signal is sent to a receiver 65 (FIG. 12) on the gas shut-off valve 55. The gas shut-off valve 55 then closes to restrict flow of gas within the gas line 52. Similarly, when the home system-off control 62 (FIGS. 2, 4), 35 (FIGS. 6, 10), 64 (FIG. 11) is engaged a system-off signal can be sent to both the water valve 15 and to the gas shut-off valve 55 to allow fluid flow in both systems. Optionally, a separate gas system-on activation button 33 (FIG. 10) and gas system-off control 72 (FIG. 10) can be included to allow the gas to be shut off independently of the water.

In summary, the user-activated controlling device supplies a convenient user interface allowing the user to remotely shut off the building's fluid flow and to easily deactivate the system to allow fluid flow to commence again. Optional functions include a time delay to the system-on signal, display of metered fluid usage amounts over a variety of time frames, and display of the temperature of the hot and cold water. The flow interface can be installed in a suitable location within the pipe of any fluid for which remote shut off and fluid data display would be advantageous. These include, for example, milk in lines on a dairy farm, fire safety sprinkler supply lines, supply lines to self-serve drink dispensers, supply lines carrying liquid farm chemicals, piped water heating systems, water lines to green houses, liquid chemical piping, gasoline lines at service stations, etc. The system can remain open and accessible or can be installed within a wall or behind another covering. If installed in a wall, the wall may be repaired and resealed (with or without a window for viewing the system) or a door may be installed to give convenient access for maintenance. The system may also be integrated into a home or business security system.

An additional benefit of the remotely activated fluid control system is a potential reduction in insurance rates or a subsidy from insurance companies for the purchase cost, as costs to provide insurance for fluid leakage damage would be reduced.

Since many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalents.

What is claimed is:

1. A fluid control system, comprising:
a flow interface system comprising a first shut-off valve, wherein said flow interface system is configured to receive a system-on signal and a system-off signal, and configured to selectively control the flow of a first fluid in a first fluid supply line in response to the receipt of one of said system-on signal and said system-off signal by causing said first shut-off valve to restrict fluid flow in response to the receipt of said system-on signal and by causing said first shut-off valve to allow fluid flow in response to said system-off signal; and
a user-activated controlling device comprising a plurality of user-input buttons and configured for communication with said flow interface system; and wherein said plurality of user-input buttons comprise a system-on control and a system-off control; and wherein the manual engagement of said system-on control triggers the sending of said system-on signal to said flow interface system; and wherein the manual engagement of said system-off control triggers the sending of said system-off signal to said flow interface system.

2. The fluid control system, as recited in claim 1, wherein:
said user-activated controlling device is electrically connected to said flow interface; and
said user-activated controlling device consists of one of a fluid control panel, a home security system control panel, and a fluid control panel in wireless communication with a key fob-type controlling device.

3. The fluid control system as recited in claim 2, wherein said flow interface system further comprises a second shut-off valve configured to selectively control the flow of a second fluid in a second fluid supply line in response to the receipt of one of said system-on signal and said system-off signal by causing said second shut-off valve to restrict fluid flow in response to the receipt of said system-on signal and by causing said second shut-off valve to allow fluid flow in response to said system-off signal.

4. The fluid control system, as recited in claim 1, wherein:
said flow interface system further comprises a receiver operable for wirelessly receiving said system-on signal and said system-off signal;
said user-activated controlling device further comprises a transmitter operable for wirelessly sending said system-on signal and said system-off signal; and
said user-activated controlling device consists of one of a fluid control panel, a key fob-type controlling device, a home security system control panel, and a fluid control panel in wireless communication with a key fob-type controlling device.

5. The fluid control system as recited in claim 4, wherein said flow interface system further comprises a second shut-off valve configured to selectively control the flow of a second fluid in a second fluid supply line in response to the receipt of one of said system-on signal and said system-off signal by causing said second shut-off valve to restrict fluid flow in response to the receipt of said system-on signal and by causing said second shut-off valve to allow fluid flow in response to said system-off signal.

6. The fluid control system, as recited in claim 1, wherein said first fluid is water.

7. The fluid control system, as recited in claim 1, wherein said first fluid is gas.

8. The fluid control system, as recited in claim 1, wherein said first fluid is a fluid other than gas or water.

9. The fluid control system, as recited in claim 1, wherein:
said plurality of user-input buttons further comprises a delay button configured to be manually engaged; and
said user-activated controlling device is configured to, upon engagement of said delay button, transmit the system-on signal after a pre-set length of delay time.

10. The fluid control system, as recited in claim 9, wherein the restriction of the flow of said first fluid by said first shut-off valve, in response to said system-on signal, consists of one of a restriction to no fluid flow and a restriction to a very low, preset residual flow rate.

11. The fluid control system, as recited in claim 1, wherein the restriction of the flow of said first fluid by said first shut-off valve, in response to said system-on signal, consists of one of a restriction to no fluid flow and a restriction to a very low, preset residual flow rate.

12. The fluid control system, as recited in claim 11, wherein:
said flow interface system is further configured to obtain and provide fluid system data; and
said user-activated controlling device further comprises a control panel comprising at least one display screen, wherein said plurality of user-input buttons are disposed on said control panel; and wherein said control panel is operable to receive said fluid system data; wherein said control panel is operable to calculate a fluid usage amount based on said fluid system data; and wherein said at least one display screen is operable to display said fluid usage amount.

13. The fluid control system, as recited in claim 1, wherein:
said flow interface system is further configured to obtain and provide fluid system data; and
said user-activated controlling device further comprises a control panel comprising at least one display screen, wherein said plurality of user-input buttons are disposed on said control panel; wherein said control panel is operable to receive said fluid system data; wherein said control panel is operable to calculate a fluid usage amount based on said fluid system data; and wherein said at least one display screen is operable to display said fluid usage amount.

14. The fluid control system as recited in claim 13, wherein said at least one display screen comprises multiple display screens.

15. The fluid control system as recited in claim 13, wherein:
said fluid system data comprise fluid usage data;
said flow interface system comprises a metering device;
said metering device is operable to measure fluid flow to derive said fluid usage data; and
said flow interface system is operable to transmit said fluid usage data to said control panel.

16. The fluid control system as recited in claim 15, wherein:
said control panel further comprises at least one preselected time fluid usage display;
said plurality of user-input buttons comprises a manually engageable preselected time fluid usage button;
said control panel is operable to calculate a fluid usage total for a preselected length of time based on said fluid system data; and
said preselected time fluid usage display comprises a fluid usage total for said preselected length of time.

17. The fluid control system as recited in claim 15, wherein:
said control panel further comprises a current usage display;
said plurality of user-input buttons comprises a manually engageable current usage button; and
said control system is operable, upon manual engagement of said current usage button, to initialize the current usage display at zero, to calculate the current fluid flow amount from the time of engagement of said current usage button based on said fluid system data, and to increment said current usage display with the said current fluid flow amount.

18. The fluid control system as recited in claim 15, wherein:
said fluid system data further comprise hot water temperature data;
said flow interface system further comprises a hot water temperature sensor operable to sense the temperature of water and to provide hot water temperature data; and
said at least one display screen is operable to display said hot water temperature data on said at least one display screen.

19. The fluid control system as recited in claim 15, wherein said first shut-off valve and said metering device are formed as an integral unit.

20. The fluid control system as recited in claim 13, wherein said control panel is further configured to operate a home security system.

21. A plumbing control system, comprising:
a control panel configured with at least one display screen, a manually engageable system-on control, a manually engageable home system-off control, and a manually engageable delay button; wherein said control panel is operable to wirelessly transmit a system-on signal based on the engagement of said system-on control; wherein said control panel is operable to wirelessly transmit a system-off signal based on the engagement of said home system-off control; wherein said control panel is operable to increment a system delay based on the manual engagement of said delay button; and wherein said control panel is configured to retard the sending of said system-on signal an amount of time equal to said system delay; and wherein said control panel is operable to receive metered water usage data;
a shut-off valve operable to control the water flow within a water supply line;
an actuator comprising a receiver operable for wirelessly receiving a system-on signal and for wirelessly receiving a system-off signal; wherein, in response to receipt of said system-on signal, said actuator is configured to cause the shut-off valve to restrict the flow of water to a very low, preset residual flow rate; and wherein, in response to receipt of said system-off signal, said actuator is configured to cause the shut-off valve to allow the flow of water;
a flow metering device operable to measure the flow in said water supply line to obtain said metered water usage data; and
a transmitter operable to wirelessly transmit said metered water usage data from said flow metering device to said control panel; wherein said control panel is operable to calculate a daily water usage total, a monthly water usage total, and a current water usage total based on said metered water usage data; and wherein said at least one display screen is operable to display said daily water usage total, said monthly water usage total, and said current water usage total.

22. A plumbing control system, comprising:
a control panel configured with at least one display screen, a manually engageable system-on control, a manually engageable home system-off control, and a manually engageable delay button; wherein said control panel is operable to transmit a system-on signal based on the engagement of said system-on control; wherein said control panel is operable to transmit a system-off signal based on the engagement of said home system-off control; wherein said control panel is operable to increment a system delay based on the manual engagement of said delay button; wherein said control panel is configured to retard the sending of said system-on signal an amount of time equal to said system delay; and wherein said control panel is operable to receive metered water usage data;
a shut-off valve operable to control the water flow within a water supply line;
a flow metering device operable to measure the flow in said water supply line to obtain said metered water usage data; and
an actuator electrically connected to said control panel and configured to receive a system-on signal and a system-off signal; wherein, in response to receipt of said system-on signal, said actuator is configured to cause the shut-off valve to restrict the flow of water to a very low, preset residual flow rate; wherein, in response to receipt of said system-off signal, said actuator is configured to cause the shut-off valve to allow the flow of water; and wherein said at least one display screen is operable to display said daily water usage total, said monthly water usage total, and said current water usage total.
